(19) United States
(12) Patent Application Publication
(10) Pub. No.: US 2008/0246246 A1
(43) Pub. Date: Oct. 9, 2008

(54) WHEELCHAIR PROPULSION AND EXERCISE ATTACHMENT

(75) Inventors: Rollin C. Dix, Chicago, IL (US); Rahuljit Pal, New Delhi (IN)

Correspondence Address: PATZIK, FRANK & SAMOTNY LTD., 150 SOUTH WACKER DRIVE, SUITE 1500, CHICAGO, IL, 60606, US

(73) Assignee: PAT PENDING MARKETING, INC., Chicago, IL (US)

(21) Appl. No.: 12/142,605

(22) Filed: Jun. 19, 2008

Related U.S. Application Data
(63) Continuation-in-part of application No. 11/532,791, filed on Sep. 18, 2006.
(60) Provisional application No. 60/945,214, filed on Jun. 20, 2007.
(60) Provisional application No. 60/722,676, filed on Sep. 30, 2005.

(51) Int. Cl. B62M 1/12

(52) U.S. Cl. 280/233

(57) ABSTRACT

A propulsion and exercise device for attaching to a conventional wheelchair having: at least one drive wheel operably interposed between the rear set of wheelchair wheels. A telescoping mast may connect the drive wheel axle to pedals to permit the pedals to be selectively moved from a stowed position to an extended position for use. Power is transmitted from the pedals to the drive wheel through a chain drive that passes over idler sprockets that maintain the chain length during adjustment of the telescoping mast.

This application claims benefit to U.S. provisional patent application Ser. No. 60/945,214, filed Jun. 20, 2007, the entirety of which is hereby incorporated by reference, and is a continuation-in-part patent application of U.S. patent application Ser. No. 11/532,791, the entirety of which is hereby incorporated by reference, which claims priority to U.S. provisional patent application Ser. No. 60/722,676, filed Sep. 30, 2005, the entirety of which is hereby incorporated by reference.

### FIELD OF THE INVENTION

The invention known as the “Pedalong” is a foot-powered attachment for propulsion by and therapeutic exercise for the seated user of a wheelchair.

### BACKGROUND

Wheelchair mobility improvements and exercising devices have been developed by numerous inventors. Beddome et al. (U.S. Pat. No. 5,242,179) discloses a four limb exercising attachment for wheelchairs which will also propel the wheelchair. In one embodiment, the Beddome device incorporates a fifth wheel connected by chain drive to pedals mounted on a mast which extends forward of the chair seat. Further, one segment of the chain drive telescopes to shorten when the drive is stowed; however, a substantial part of the chain drive extends beyond the wheelchair frame when in the stowed position.

Berkheimer (U.S. Pat. No. 5,273,304) discloses a leg-powered, lean-steerable attachment for a wheelchair. This device attaches to the underside of the wheelchair with a pole extending forward and carrying a bearing for a vertical axis about which steering of a pedaled front wheel occurs. This new front wheel lifts the wheelchair's two front wheels so the combination behaves like a tricycle.

Long et al. (U.S. Pat. No. 6,910,701) discloses a wheelchair propulsion using hand cranks driving sprockets which (through chain connection) drive the large rear wheels of the chair. The cranks reciprocate, rather than rotate through 360 degrees to ease the user's task.

McKelvey (U.S. Pat. No. 5,207,286) discloses a bicycle-like front end for a wheelchair with pumping rather than rotating pedals.

Merlan (U.S. Pat. No. 3,485,510) powers the wheelchair's forward motion with hand-cranked pedals above a chain-driven front wheel. This assembly is on a pivotable support for steering.

Adams (U.S. Pat. No. 6,409,195) discloses a “sport-type” wheelchair which is tricycle-form with the pedals driving the rear wheels through a chain and sprockets.

Benz (U.S. Pat. No. 3,912,032) discloses a gasoline engine powered front end for a wheelchair. This front-end device attaches and lifts the front two wheels of the wheelchair converting it into a tricycle.

Salmon (U.S. Pat. No. 6,092,822) discloses a wheelchair having a pedal operated transmission to drive a pair of rear wheels.

Van Vooren (U.S. Pat. No. 5,066,032) merges a hand-driven bicycle at the front end of a wheelchair and lifts the forward wheels of the wheelchair with attachment of the bicycle. The apparatus may be adjusted in height or width during the initial assembly only, but it does not permit the adjustment of the position of the pedal assembly forward or backward (e.g., to be able to position the pedal assembly substantially under the seat).

Young (U.S. Pat. No. 4,471,972) discloses a hand-driven front end to the wheelchair which lifts the front wheels of the wheelchair.

Durham et al. (U.S. Pat. No. 4,572,501) disclose an exercise attachment which fits under and lifts the wheelchair's front wheels from the ground. The device is claimed to also have a propulsion mode. The attachment has four wheels which are in front of the wheelchair when attached.

Moore (U.S. Pat. No. 4,824,132) discloses an arm exercise device connecting to the front of the wheelchair. Moore's device also has a propulsion mode in which a forward wheel is lowered to the ground raising the wheelchair's front two wheels.

A published Japanese patent application (Publication No. 2003-339779; published Dec. 2, 2003) owned by Honda Seiki KK, discloses a pedal drive type wheelchair. In the Honda device, the front wheels function as drive wheels and the rear wheels function as steering wheels. The seat is movable longitudinally to adjust for the size of the user as well as rotationally, to ease entry and exit from the device. Steering is provided by way of a steering shaft connected to gearing serving to turn the rear wheels.

Finally, Honda Rikio describes a foot-operated wheelchair driving mechanism in Japan Patent Abstract 2004-065887 published on 3 Apr. of 2004. His device incorporates a driving pedal system in front and a driving fifth wheel in the rear both mounted on a connecting gear case which pivots at a shaft fixed to the frame of the wheelchair and penetrating across at the front of the gear case. The rear part of the gear case is pushed down by a spring fixed to the frame of the wheelchair rearward of the pivot, thus supplying grounding pressure.

The present invention differs from and provides improvements over this Honda design in its elimination of the forward pivot and hold-down spring and in its connection of the rear wheel axle rigidly to the wheelchair frame. This rigid connection eliminates the tendency of the hold-down spring to pitch the wheelchair forward. Also, pivoting about the rear wheel axle permits the raising and lowering, and telescoping, of the system for greatly improved user access and adjustability to user size.

### SUMMARY OF THE INVENTION

The invention (generally referred to as the “Pedalong”) disclosed herein is for both exercise and propulsion of wheelchair-bound individuals. These decreased mobility individuals include the very elderly, recovering accident, stroke, and heart attack victims, and chronic disease victims like those with cerebral palsy, MS, obesity and diabetes.

In a first embodiment of the device, the Pedalong contains a “fifth wheel” located between the rear wheels and rotating on its own horizontal axle below this fixed rear wheel axis. This fifth wheel's lower edge is adjusted relative to the lower edge of the two rear wheels so that most of the user's weight is divided between the fifth wheel and one or the other of the rear wheels. Of course, part of the user's weight is carried on the two front wheels. On this fifth wheel axle, a telescoping tube is mounted to support the pedals. From the pedals, power is transmitted to the fifth wheel by a chain drive. The telescoping tubes permit the length, and an adjustable front support permits the height of the pedals, to be adjusted by the therapist or the user. The placement of the telescoping tubes above the rear axle also enables retraction of the pedal mechanism under the chair for stowage.

A collet-like clamp or other fastening mechanism secures the forward, inner tube within the rear, outer tube at the properly adjusted length. A set of idler sprockets adjusts the total chain path length to retain chain tension during extension of the system. The pedal/front axle assembly is releasably connected to the drive sprocket so that the wheelchair can be pushed without the pedals rotating while they are retracted.

Steering can be accomplished by turning one of the front wheels with a handle or steering arm mounted at the armrest level, or by the user's leaning in the direction of the desired turn and continuing to pedal the fifth wheel while retarding the rear wheel now on the ground. The front wheels are on castors and follow the steering movement for either method of steering by the occupant of the wheelchair. It is also possible for the therapist or attendant to completely control direction of movement by simply pushing the wheelchair in the desired direction.

An electric motor and controller may be added to assist the pedaled drive. Also, motors may be provided for electrically lifting and/or telescoping the adjustment for user size and for ease of access for the user. Alternatively, a multi-speed capability may be added by, for example, incorporating a conventional three-speed bicycle rear axle in the chain drive.

A brake may be provided for slowing, stopping or parking the wheelchair, as well as a “deadman switch” that releases the propulsion system to allow motion only when activated by the user.

In a second embodiment of the present invention, the rear axle carries two wheels and the attachment brackets for the rear axle are easily adjusted for height. This permits either or both of the large wheels to be lifted from the ground as selected by the user. In this configuration, the entire rear axle rotates. To allow cornering, either one of the wheels may be loose on the axle or a conventional differential may be used.

In a third embodiment of the present invention, the rear axle carries two wheels, the attachment brackets for this rear axle are locked, the rear axle is driven by the driven sprocket, one or both wheels are driven, and the original wheelchair rear wheels may be eliminated.

Any of these embodiments can be supplied in small, medium and large main frame lengths to accommodate different users, and with other combinations of the features described. To motivate the user and assist the therapist, an odometer may be mounted on the front end of the device.

The invention likewise comprises: a wheelchair device having any of the propulsion and exercise systems described above attached.

The present invention is also directed to a method for converting a conventional wheelchair, having a frame with at least two structural rails, pivoting front wheels, a rear set of laterally spaced wheels and a surface for supporting the user, to a propulsion and exercise device. The method comprises the step of operably attaching any of the propulsion and exercise systems described above to the wheelchair using brackets at both ends of both the rear axle and the front crossbar. It is important that the Pedalong attaches to most conventional wheelchairs because individual comfort and operability is possible only with proper fitting of the wheelchair to the individual.

### BRIEF DESCRIPTION OF THE DRAWINGS

FIG. 1 is a side perspective view of the Pedalong's first embodiment attached to a conventional wheelchair.

FIG. 2 is a rear view of FIG. 1.

FIG. 3 is a side view of the wheelchair and Pedalong shown in FIG. 1 with the right side of the wheelchair removed.

FIG. 4 is a side view of the wheelchair and Pedalong shown in FIG. 3 showing the Pedalong in a retracted position.

FIG. 5 is a top perspective view showing one embodiment of the Pedalong.

FIG. 6 is a top perspective view showing the Pedalong of FIG. 5 with its front and rear supports removed.

FIG. 7 is a side view showing the Pedalong of FIG. 6 with the drive wheel removed.

FIG. 8 is a partial perspective view showing the collet and front support of one embodiment of the Pedalong installed on a wheelchair.

FIG. 9 is a partial perspective view showing the connection between the pedal assembly and front sprocket for the Pedalong shown in FIG. 6.

FIG. 10 is a rear view of an embodiment of the Pedalong with the drive wheels locked down and the original wheelchair rear wheels eliminated.

### DETAILED DESCRIPTION OF THE INVENTION

While this invention is susceptible of embodiment in many different forms, there is shown in the drawings, and will herein be described in detail, several specific embodiments, with the understanding that the present disclosure is to be considered merely an exemplification of the principles of the invention and the application is limited only to the appended claims.

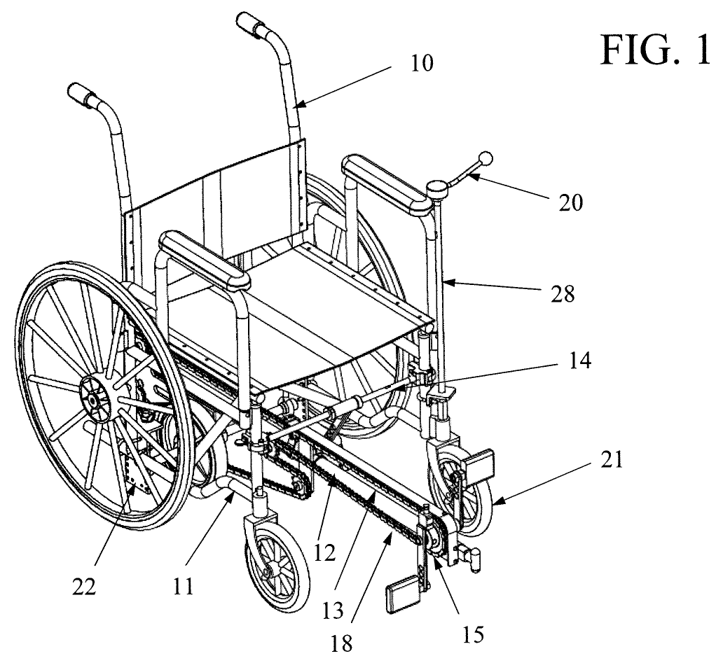

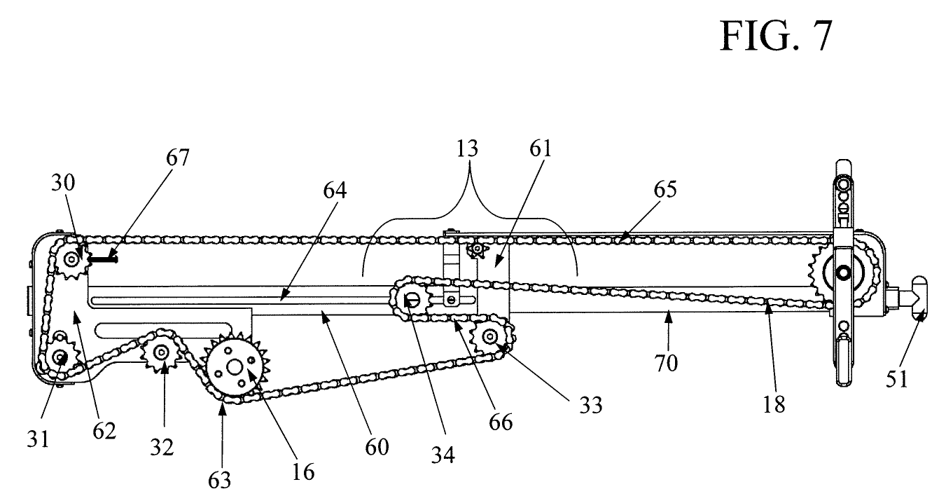

FIG. 1 shows a conventional wheelchair 10 with its structural rails 11 providing connection for its four wheels and with the chain-driven first embodiment of the Pedalong 12 located between and supported between these rails. Front cross rod or support assembly 14 connects to the rails, and provides a rigid connection for the mast 13. A drive chain 18 connects the drive sprocket 15 and wheel or driven sprocket 16 (shown on FIG. 7). Steering arm 20 connects through a vertical shaft 28 to the front wheel 21.

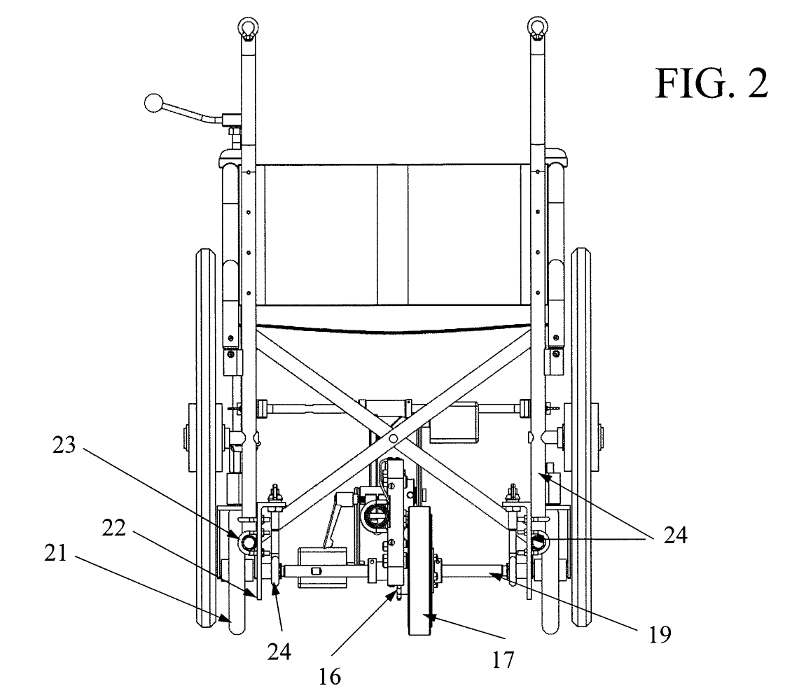

FIG. 2 is a rear view of the wheelchair and attached Pedalong. The drive wheel 17 and wheel sprocket 16 are interconnected. While one drive wheel is shown, it is appreciated that multiple drive wheels may be used and not depart from the scope of the present invention. This assembly is then supported by a wheel or rear axle 19 which connects to the structural rails 11 through a pair of adjustable brackets 22. U-bolts 23 or other fasteners may be used to secure the brackets 22 to the structural rails. Eyebolts 24 then connect to the wheel axle 19. It is appreciated that in the case of multiple drive wheels, the height of the wheels may be adjusted using the adjustable brackets or other known means to permit a user to selectively engage the drive wheels and lift of one or both of the wheelchair's rear wheels off the ground.

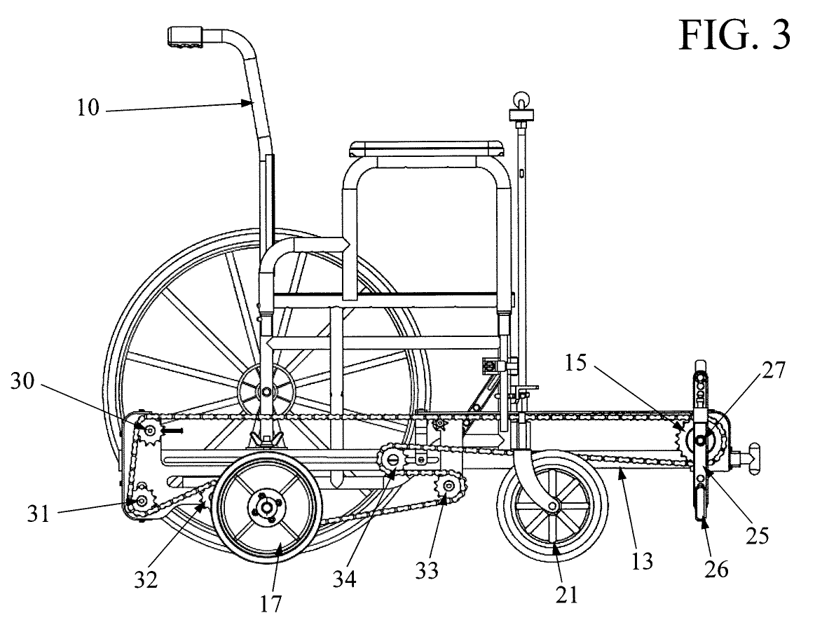

As shown on FIG. 3, the front drive assembly, or pedal and driving sprocket assembly, contains pedal arms 25, pedals 26, the drive axle 27, and drive sprocket 15. The chain path passes over drive sprocket 15, idler sprockets 30, 31, 32 (partially hidden by the rear wheel 17), wheel sprocket 16 (completely hidden by the rear wheel 17, but shown in FIG. 7), and then idler sprockets 33 and 34. The length of the mast 13 is telescopically adjustable and the idler sprockets maintain chain length when the mast telescopes.

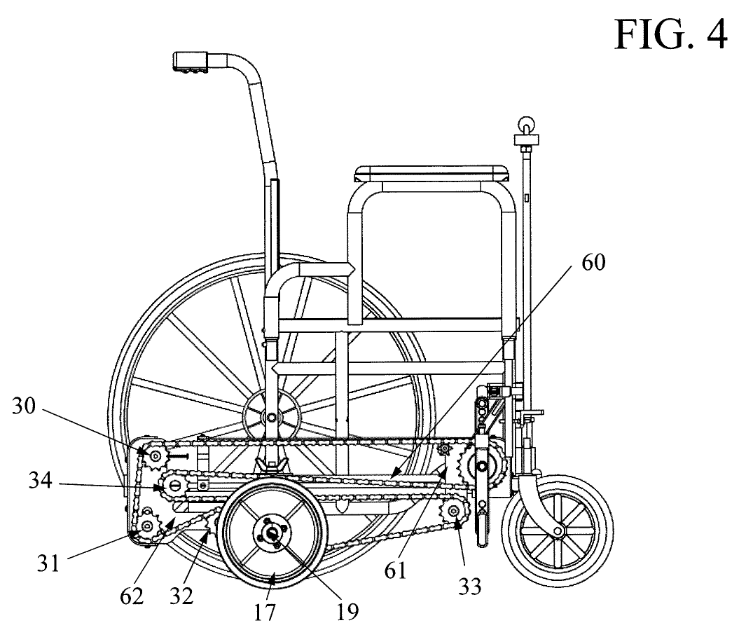

In FIG. 4, the pedals are shown retracted under the seat of the wheelchair. Use of the idler sprockets 30 and 31 spreads the chain so that idler sprocket 34 can move rearward above the wheel axle 19. Plate 62 carries a sleeve which, during mast angle adjustment, rotates on the fixed wheel axle 19. The outer tube 60 is fixed to plate 62 as are the idler sprockets 30, 31, and 32 (partially hidden by the rear wheel 17). Idler sprocket 33 is supported from front plate 61 attached to the right end of the outer tube 60.

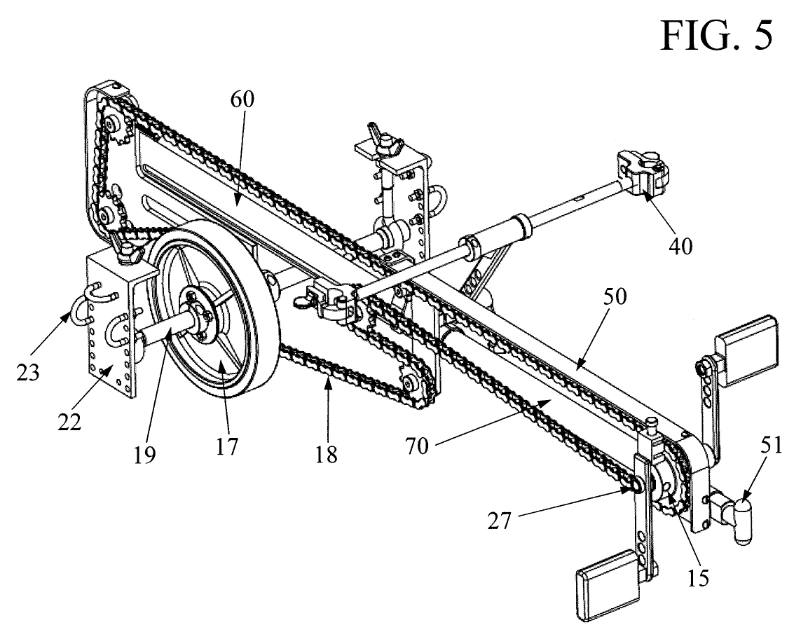

FIG. 5 shows the Pedalong without the wheelchair. The adjustable brackets 22 and the front support brackets 40, the outer tube 60 and the inner tube 70 of the telescoping mast extend forward from the wheel axle 19 to the drive axle 27, which carries the drive sprocket 15.

Drive chain 18 transfers the drive axle 27 rotation to the wheel sprocket 16 (completely hidden by the drive wheel 17) which is connected to drive wheel(s) 17. The chain is serpentinely looped around a set of idler sprockets to provide length adjustability as set forth in more detail below. Chain guard 50 may be used to provide safety and/or improve the appearance. A handle 51 or other object to permit a user to firmly grasp may be used to pull the inner tube forward to the desired extension. It is also appreciated that an electrically powered extension-retraction screw may be operably attached to the mast to facilitate adjustment and movement of the mast.

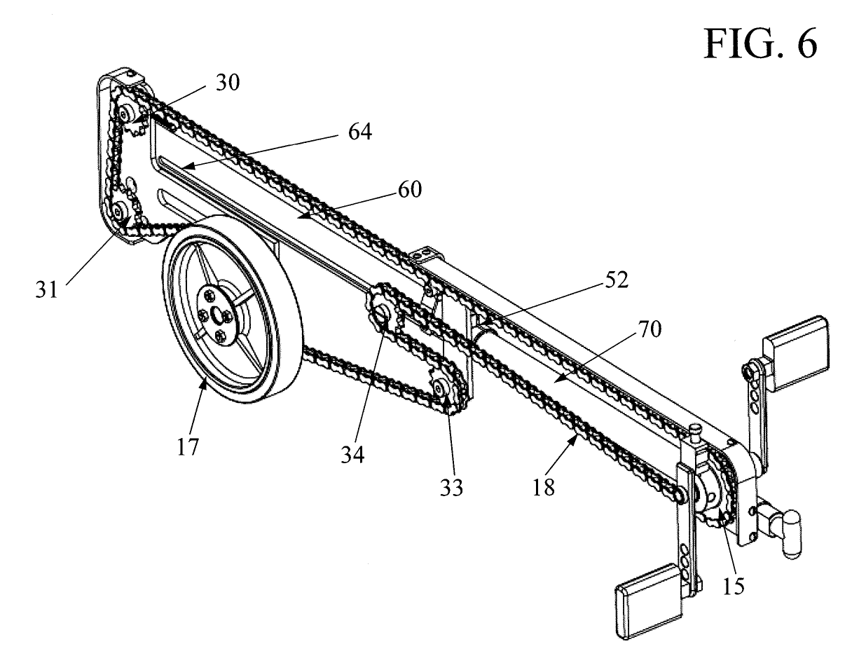

In FIG. 6, the Pedalong is shown in an extended position, illustrating the forward movement of sprocket 34 toward sprocket 33 (as compared to the retracted Pedalong in FIG. 4). This movement occurs because sprocket 34 is mounted on a shaft which extends from its mounting on the inner tube 70 through the slot 64 on the outer tube 60.

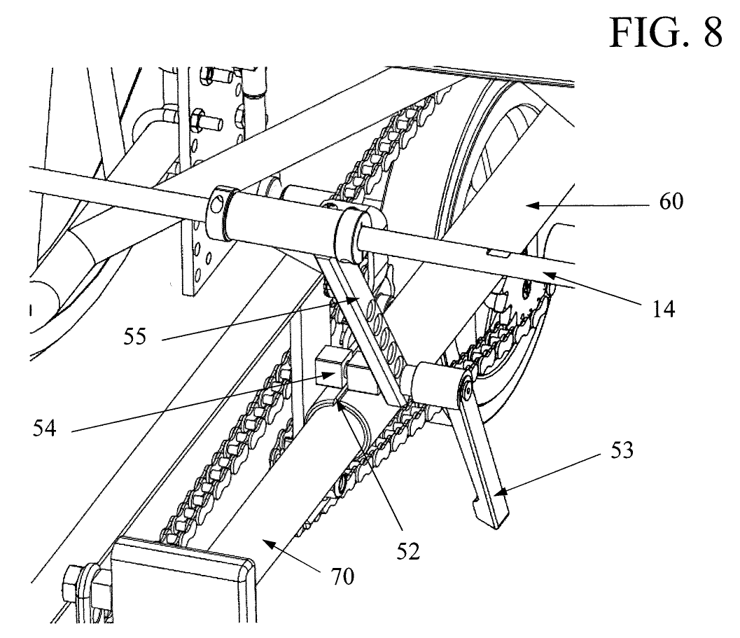

FIG. 7 has the wheel and axle removed revealing wheel sprocket 16 and idler sprocket 32 which increases the wrap of chain 63 on wheel sprocket 16. When a user (e.g., the therapist) releases collet (as shown in FIG. 8) and pushes leftward on handle 51 to shorten the mast 13, the inner tube 70 slides leftward in outer tube 60 carrying sprocket 34 to the left. With this motion, the upper chain strand 65 shortens, and the lower strand 66 lengthens by equal amounts. This action preserves the chain tension which had been earlier adjusted with screw 67 pushing on the mounting of sprocket 30.

To permit reduction of the overall height of the Pedalong, sprocket 16 can be moved to the opposite side of plate 62 and beyond tube 60 so that rear axle 19 can be moved up to nearly touch chain 66. A new sprocket may be placed on the shaft with sprocket 31 to carry a new, short chain to the relocated drive sprocket 16.

Further, sprocket 32 is eliminated and sprocket 31 raised so that chain 63 goes straight from sprocket 31 to sprocket 33. The effect of these changes is an approximately 20% height reduction that allows the pedals to be raised to an improved operating position when Pedalong is mounted on a conventional wheelchair.

FIG. 8 shows one embodiment of the collet mechanism and front support of the outer tube in detail. When the therapist tightens the threaded handle 53 onto the front block 54 which is welded on to the outer tube 60, the split 52 (running through both the outer tube and the block) closes down and holds the inner tube 70 at the desired extension length by friction. The threaded handle 53 passes through one of the holes on the vertical guide 55, which is attached to the front cross rod 14, to permit the user to change the height of the pedals relative to the ground and to provide a rigid front support for the Pedalong. While a collet-type fastener is shown and disclosed, it is appreciated that other known locking devices or means to selectively position the tubes relative to one another may be used and not depart from the use of the present invention.

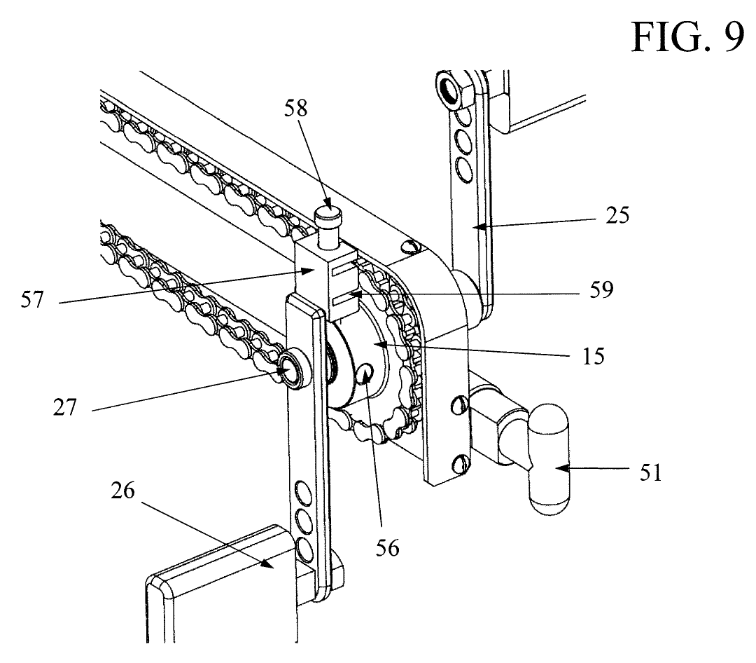

FIG. 9 shows details of one embodiment of the front drive assembly engagement. Blind hole 56 in the drive sprocket 15 hub accepts pin 58 which is retained by holder 57. Pin 58 has a small side pin (not shown) which slides into either of the slots 59 in holder 57 to engage or disengage the drive.

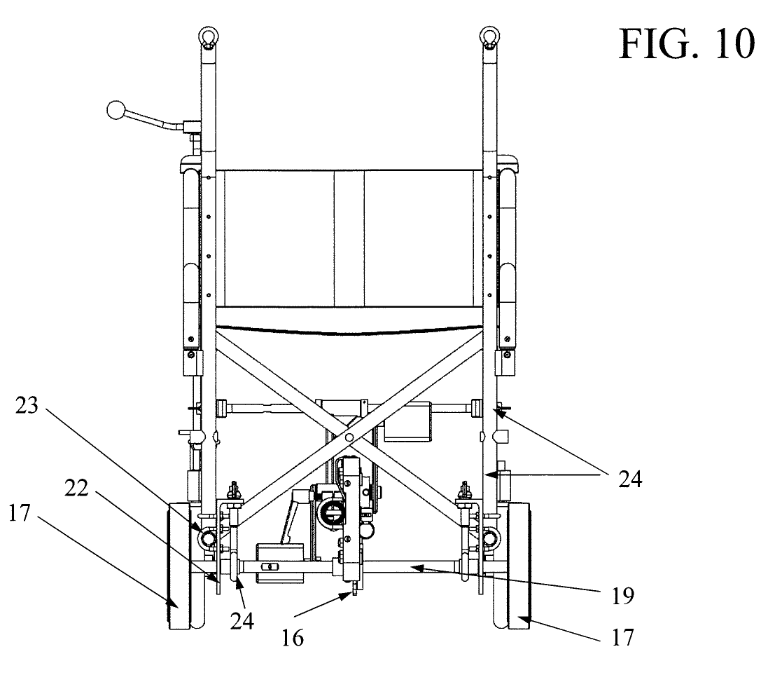

FIG. 10 shows an embodiment of the Pedalong with the drive wheels 17 locked down and the original wheelchair rear wheels eliminated such that the wheelchair rests on the drive wheels 17. In operation, the drive wheels 17 are spaced apart on the rear axle 19, which rotates upon use of the propulsion and exercise system to drive the wheels 17. It is appreciated that only one of the wheels 17 on the rear axis may be driven (i.e., act as a drive wheel) and not depart from the scope of the present invention.

It will be understood that modifications and variations may be effected without departing from the scope of the novel concepts of the present invention, but it is understood that this application is limited only by the scope of the appended claims. In particular, all references to chain and sprockets apply equally to belt and pulley arrangements.

What is claimed is:

1. A wheelchair propulsion and exercise device mountable under the seat of a wheelchair having a pair of rear wheels, a rear and a front, the wheelchair propulsion and exercise device comprising:
a rear axle carrying at least one drive wheel connected with a driven sprocket, the rear axle connected to the wheelchair by left and right rear brackets;
a front support assembly connected to the wheelchair by left and right front brackets;
the rear axle and front support assembly together providing support for a singly telescoping mast having an outer tube within which slides an inner tube that carries at its forward end a pedal and driving sprocket assembly that is positioned substantially under the wheelchair seat when retracted, the pedal and driving sprocket assembly having a pair of pedals and a driving sprocket; and
a chain interconnecting the driving and driven sprockets and passing over multiple idler sprockets that are supported from the inner and outer tubes in a manner that retains chain tension during telescoping mast length change.

2. The wheelchair propulsion and exercise device of claim 1 with the outer tube passing above the rear axle so as to substantially extend from the rear to the front of the wheelchair, and thereby contain an inner tube long enough to extend the pedals from a retracted position substantially under the wheelchair seat to a user-selected forward position.

3. The wheelchair propulsion and exercise device of claim 2 which further comprises a locking device on the outer tube for selectively securing the inner tube at various positions relative to the outer tube.

4. The wheelchair propulsion and exercise device of claim 3 with the pedal and driving sprocket assembly comprised of a pedal-axle subassembly which is releasably lockable to the driving sprocket.

5. The wheelchair propulsion and exercise device of claim 4 wherein one idler sprocket is supported on a shaft attached to a rear portion of the inner tube and extending through a slot in the outer tube.

6. The wheelchair propulsion and exercise device of claim 3 wherein the locking device comprises a collet-like slot in the end of the outer tube pulled tight by a screw that simultaneously locks the telescoping mast securely to the front support assembly.

7. The wheelchair propulsion and exercise device of claim 1 which further comprises a tube connecting the driven sprocket to a drive wheel offset from the center of the wheelchair so that the wheelchair rests on the drive wheel and one of the rear wheels, while the opposite rear wheel is elevated to prevent its touching a ground surface.

8. The wheelchair propulsion and exercise device of claim 1 which further comprises an electrically powered extension-retraction screw operably connected to the telescoping mast.

9. The wheelchair propulsion and exercise device of claim 1 which further comprises a two wheel driven rear axle with one or both wheels driven.

10. The wheelchair propulsion and exercise device of claim 1 wherein the pair of rear brackets are adjustable brackets to permit the height of the at least one drive wheel to be selectively adjusted to lift one or both of the rear wheels out of contact with a surface.

11. A wheelchair propulsion and exercise device mountable under the seat of a wheelchair having a pair of rear wheels, a rear and a front, the wheelchair propulsion and exercise device comprising:
a rear axle carrying one or more drive wheels connected with a driven sprocket, the rear axle connected to the wheelchair by left and right rear brackets;
a front support assembly connected to the wheelchair by left and right front brackets;
wherein the rear axle and front support assembly together providing support for a singly telescoping mast assembly having an outer tube within which slides an inner tube that carries at its forward end a pedal and driving sprocket assembly having two pedals, wherein the outer tube passes above the rear axle so as to extend substantially from the rear to the front of the wheelchair, whereby the inner tube is extendable from a retracted position with the pedals adjacent to the forward edge of the wheelchair seat to a user-selected extended position; and
a chain interconnecting the driving and driven sprockets and passing over multiple idler sprockets which are supported from the two tubes in a manner that retains chain tension during telescoping mast assembly length change.

12. The wheelchair propulsion and exercise device of claim 11 which further comprises a tube connecting the driven sprocket to one of the one or more drive wheels offset from the center of the wheelchair so that the wheelchair rests on the drive wheel and one of the rear wheels, while the opposite rear wheel is elevated to prevent its touching a ground surface.

13. A wheelchair propulsion and exercise device mountable under the seat of a wheelchair having a rear and a front, the wheelchair propulsion and exercise device comprising:
a rear axle carrying two wheels with at least one of the two wheels connected with a driven sprocket, the rear axle connected to the wheelchair by left and right rear brackets, wherein the wheelchair rests on the two wheels;
a front support assembly connected to the wheelchair by left and right front brackets;
wherein the rear axle and front support assembly together providing support for a singly telescoping mast assembly having an outer tube within which slides an inner tube that carries at its forward end a pedal and driving sprocket assembly having two pedals, wherein the outer tube passes above the rear axle so as to extend substantially from the rear to the front of the wheelchair, whereby the inner tube is extendable from a retracted position with the pedals adjacent to the forward edge of the wheelchair seat to a user-selected extended position; and
a chain interconnecting the driving and driven sprockets and passing over multiple idler sprockets which are supported from the two tubes in a manner that retains chain tension during telescoping mast assembly length change.
